(19) United States
(12) Patent Application Publication
(10) Pub. No.: US 2010/0325896 A1
(43) Pub. Date: Dec. 30, 2010

(54) Food handling utensil

(76) Inventor: Scott T. Hebebrand, Charleston, SC (US)

Correspondence Address: RONALD L. PHILLIPS, 1101 BERESFORD RUN, CHARLESTON, SC, 29492, US

(21) Appl. No.: 12/456,959

(22) Filed: Jun. 26, 2009

(51) Int. Cl. A47J 43/28

(52) U.S. Cl. 30/150; 30/323; 30/324

(57) ABSTRACT

A food-handling utensil has tines with opposing sides that are provided with a plurality of smooth projections spaced along the length thereof adapted to engage and retain food impaled by the tines but only marginally inhibit release of the impaled food during handling of the food. Several exemplary embodiments of the utensil are disclosed in the form of a fork having more than two tines and with various forms of the projections, the provision of projections on other sides of the times, adapting the invention to sporks and also providing the handle of the utensil with an ergonomic grip.

### TECHNICAL FIELD

This invention relates to food-handling utensils and more particularly to those having tines.

### BACKGROUND OF THE INVENTION

In the use of food-handling utensils having tines such as a fork used in eating and forks specifically designed for use in food processing and cooking on a grill, the food may be in a form where it tends to not remain on or cling to the tines during handling with the utensil. With the lack of sufficient food retention with conventional eating utensils presenting an even greater challenge in attempting to meet the needs of children, the elderly and the physically impaired.

### SUMMARY OF THE INVENTION

The present invention provides significantly enhanced food retention for a food-handling utensil having two or more tines. Wherein opposing sides of the tines are provided with a plurality of laterally extending smooth projections spaced along the length thereof adapted to enter and retain the food being impaled by the tines and provide for only marginally inhibited release of the food during handling of the food. Such as in the processing of certain foods such as raw meat and fish, in using the utensil when cooking on a grill and in using the utensil to eat.

Several exemplary embodiments of the food-handling utensil according to the present invention are disclosed with various numbers of tines and various forms and arrangements of the projections. Wherein the location of the projections is strategically extended to include other sides of the tines and tine projections of a smooth but different shape are also utilized. And wherein the invention is adapted to sporks as well as forks, the grip of the eating utensil is ergonomically enhanced and the tines are provided with blunt ends with these features especially suited for those persons who would otherwise have difficulty in adequately gripping the utensil as well as those susceptible to self-inflicted harm from eating utensils with sharp pointed ends.

Several exemplary embodiments are shown in the accompanying drawings and together with other aspects of the invention are described in detail in the accompanying description.

### DESCRIPTION OF THE DRAWINGS

FIG. 1 is a front view of a food-handling utensil embodying the present invention,

FIG. 2 is a side view taken along the lines 2-2 in FIG. 1 when looking in the direction of the arrows,

FIG. 3 is a cross-sectional view taken along the lines 3-3 in FIG. 2 when looking in the direction of the arrows,

FIG. 4 is a front view of another embodiment of a food-handling utensil in accordance with the present invention,

FIG. 5 is a front view of another embodiment of a food-handling utensil in accordance with the present invention,

FIG. 6 is a front view of another embodiment of a food-handling utensil in accordance with the present invention,

FIG. 7 is a side view taken along the lines 7-7 in FIG. 6 when looking in the direction of the arrows,

FIG. 8 is a cross-sectional view taken along the lines 8-8 in FIG. 7 when looking in the direction of the arrows,

FIG. 9 is a front view of another embodiment of a food-handling utensil in accordance with the present invention,

FIG. 10 is a side view taken along the lines 10-10 in FIG. 9 when looking in the directions of the arrows,

FIG. 11 is a cross-sectional view taken along the lines 11-11 in FIG. 10 when looking in the direction of the arrows,

FIG. 12 is a front view of another embodiment of a food-handling utensil in accordance with the present invention,

FIG. 13 is a side view taken along the lines 13-13 in FIG. 12 when looking in the direction of the arrows, and

FIG. 14 is a cross-sectional view taken along the lines 14-14 in FIG. 13.

### DESCRIPTION OF EXEMPLARY EMBODIMENTS

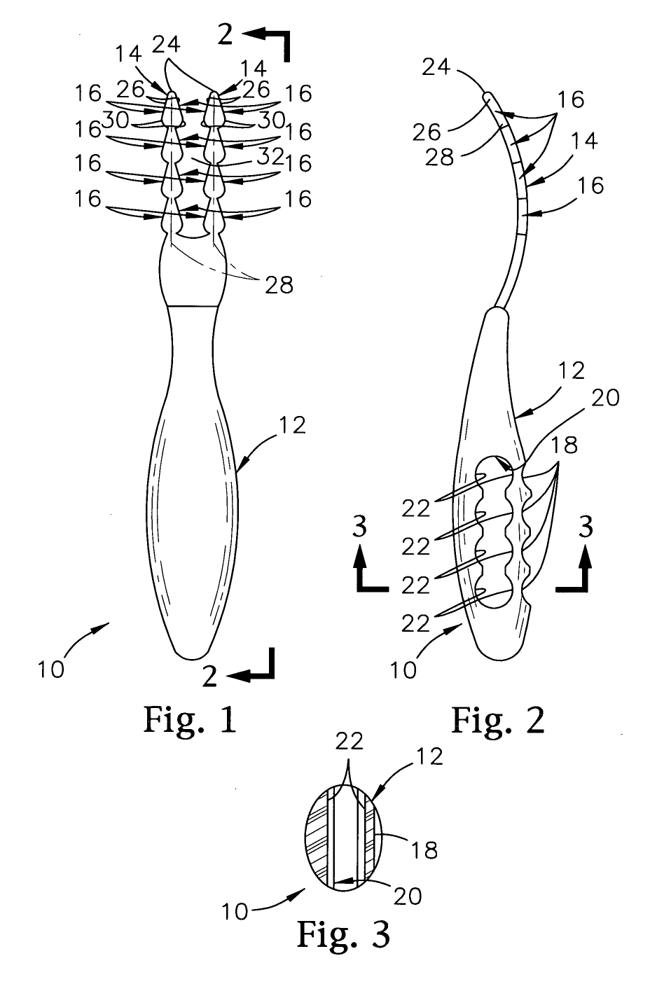

Referring to FIGS. 1-3, there is shown a food-handling utensil 10 comprising a handle 12 and a matching pair of side-by-side four-sided matching tines 14 that together with the handle define a fork suited for use in eating. And it will also be understood that the fork when provided with a significantly longer handle than that shown is well suited for use in processing certain food such as raw fish and meat and in handling food on a grill.

In the present invention in providing for significantly enhanced food retention by the food-handling utensil 10, opposite sides of the tines 14 which include the opposing or oppositely facing sides of the tines are provided with a plurality of laterally extending smooth projections 16 spaced along the length thereof that are adapted to enter and retain food impaled by the tines but only marginally inhibit release of the food when used as an eating utensil and when manipulating food such as in food processing and cooking on a grill. And thus with a food retention capability that is especially helpful for children, the elderly and the physically impaired as well as food that can otherwise be difficult to handle efficiently.

Moreover, such use is further facilitated by the handle 12 having four finger receiving notches or recesses 18 in its outer surface and also an elongated aperture 20 with a set of four oppositely facing pairs of finger receiving notches or recesses 22 by which the external notches or the internal notches can be grasped with the fingers of a hand to facilitate firm grasping of the fork. Thereby providing the fork with a versatile ergonomic grip adapted to further aid in its use and especially by children, the elderly, and the physically impaired.

In providing for such food retention and in a safe manner, the tines 14 have a rounded and thus blunt distal end 24 with a small radius adapted to readily impale food and the projections 16 on the opposite sides of each of the tines which include the opposing sides or oppositely facing sides of the tines cooperatively form a series of like, smooth, angularly oriented configurations along the length of the tines. See FIG. 1. Wherein the side of each projection 16 comprises a flat side surface 26 at its leading end that angles laterally outward at an acute angle from the tine centerline 28 in a direction away from the blunt end 24 of the tine and merges with a convex side surface 30 at its trailing end that curves inward to a point where it meets with the leading end of the next projection on this side of the tine. Thereby providing a series arrangement of the smooth angularly oriented projections 16 along the length of the tine which are symmetrical to their tine centerline 28, are laterally aligned with the projections on the adjacent tine and operate to enter and retain food at a series of locations along the length of the tines but provide only a marginally inhibiting obstacle to removal of food from the utensil during handling of the food whether in processing food, cooking on a grill or eating.

Moreover, such food retention is aided by cooperative action of the projections 16 on the oppositely facing sides of the tines in that they provide a series of relatively narrow gaps 32 there between such as the one indicated where food must pass through as the tines are forced to advance through the food. And as a result, the projections 16 on the oppositely facing sides of the tines cooperate to retain the food in a wedging manner but again in only a marginally inhibit manner to further facilitate food handling in an effective manner.

It will also be appreciated that the food-handling utensil 10 with such enhancing food retention features is of a form that can be readily manufactured in a conventional cost effective manner. For example, the handle 12 and that portion comprising the tines 14 can be made of a suitable plastic material by injection molding and either formed together as one piece or formed separately and then suitably joined together in a conventional manner. Or the handle and that portion comprising the tines can be made of different materials. For example, the handle can be made of a suitable plastic material and the portion comprising the tines can be made of a suitable metal in a conventional metal forming manner including stamping, forging or casting and then joined in a suitable conventional manner to the handle. Or both the handle and the portion comprising the tines could be made completely of a suitable metal and again in a conventional metal forming manner. And in either case, the food utensil with these enhancing features is well suited to high volume production in the most cost effective manner.

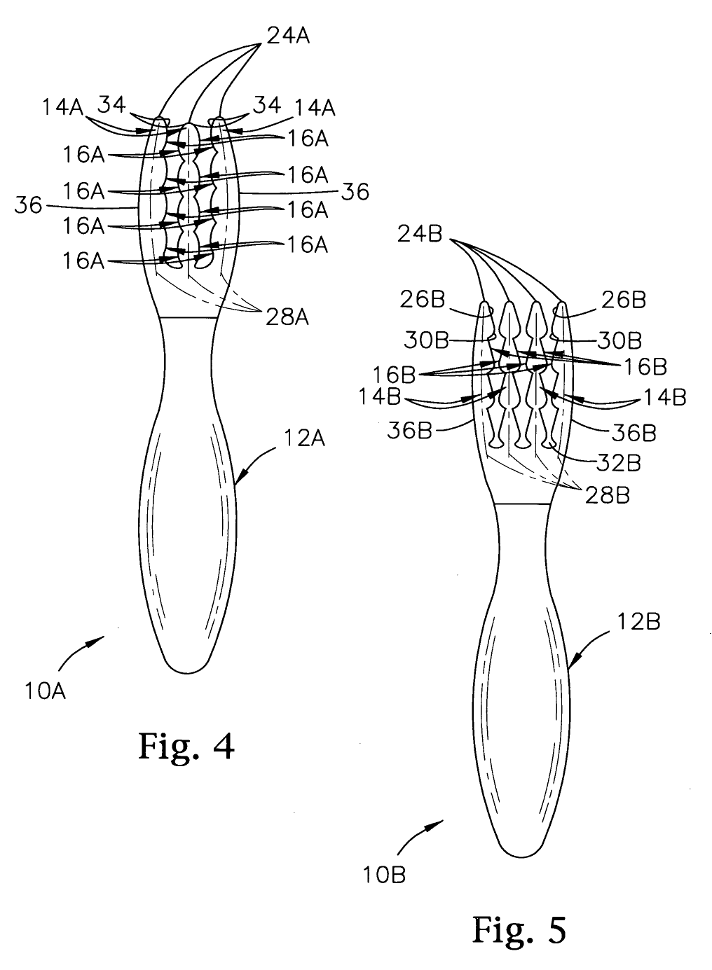

Referring now to FIG. 4, there is shown another embodiment of the food-handling utensil according to the present invention wherein the utensil and similar or like features are identified by the same reference numbers used previously but with the suffix “A” added and significantly different features are identified with new reference numbers. In this embodiment, the food-handling utensil 10A has three tines 14A each with a blunt impaling end 24A and the projections 16A on the tines have a completely convex or semi-elliptical shaped side surface 34 and are provided on only the opposing sides of the tines. And thus not on the outer side 36 of the outermost tines nor the other two sides of the tines which have a smooth uninterrupted surface extending along the length thereof that may be more suitable for use such as by those who might experience an irritation or uncomfortable feel from direct contact with an irregular or interrupted surface. And also unlike the embodiment in FIGS. 1-3, the projections on the opposing sides of the tines are not laterally aligned and instead are staggered in relation to each other so as to provide a relatively tortuous or twisted path between the tines 14A for passage of food. Whereby food is impaled by the tines along one or both of these twisted paths as adjacent tines are forced to advance through the food to thereby further assist in providing for enhanced food retention with marginal obstruction to release of the food for efficient food handling.

Referring now to FIG. 5, there is shown another embodiment of the food-handling utensil according to the present invention wherein the utensil and similar or like features are identified by the same reference numbers used previously but with the suffix “B” added. In this embodiment, the food-handling utensil 10B has four tines 14B each with a blunt impaling end 24B and the projections 16B on the tines are aligned and configured with side surfaces 26B and 30B like those in the FIG. 1-3 embodiment and like in the FIG. 4 embodiment are provided on only the opposing sides of the tines and not on their outer side 36B nor the other two sides of the tines which again may be more suitable for use by those that experience an irritation or uncomfortable sensation from direct contact with an irregular surface.

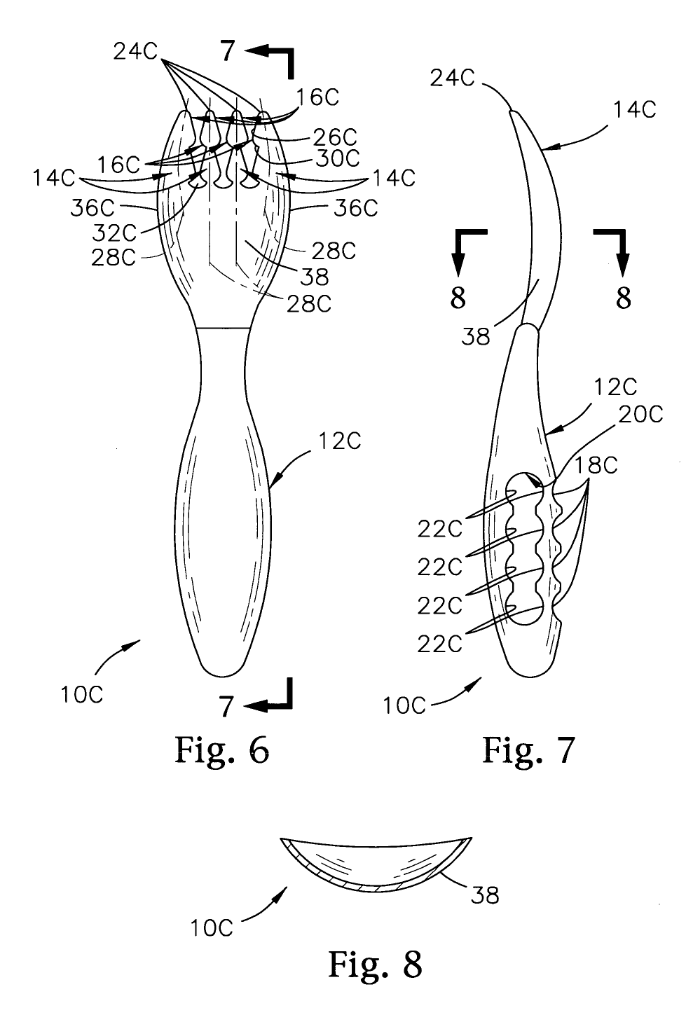

Referring now to FIGS. 6-8, there is shown another embodiment of the food-handling utensil according to the present invention wherein the utensil and similar or like features are identified by the same reference numbers used previously but with the suffix “C” added and significantly different features are identified with new reference numbers. In this embodiment, the food-handling utensil 10C has four tines 14C each with a blunt impaling end 24C and the projections 16C on the tines are aligned and have conjoint side surfaces 26C and 30C like those in the FIGS. 1-3 embodiment and are provided on only the opposing sides of the tines and not on the outer side 36C of the outermost tines nor the other two sides of the times like the FIG. 4-6 embodiments so as to be more suitable for use by those that experience an irritation or uncomfortable sensation from direct contact with an irregular surface. And in this embodiment, the tines 14C are integrally joined with a spoon shaped portion 38 to thereby define what is commonly called a spork in that it is the combination of a spoon and fork.

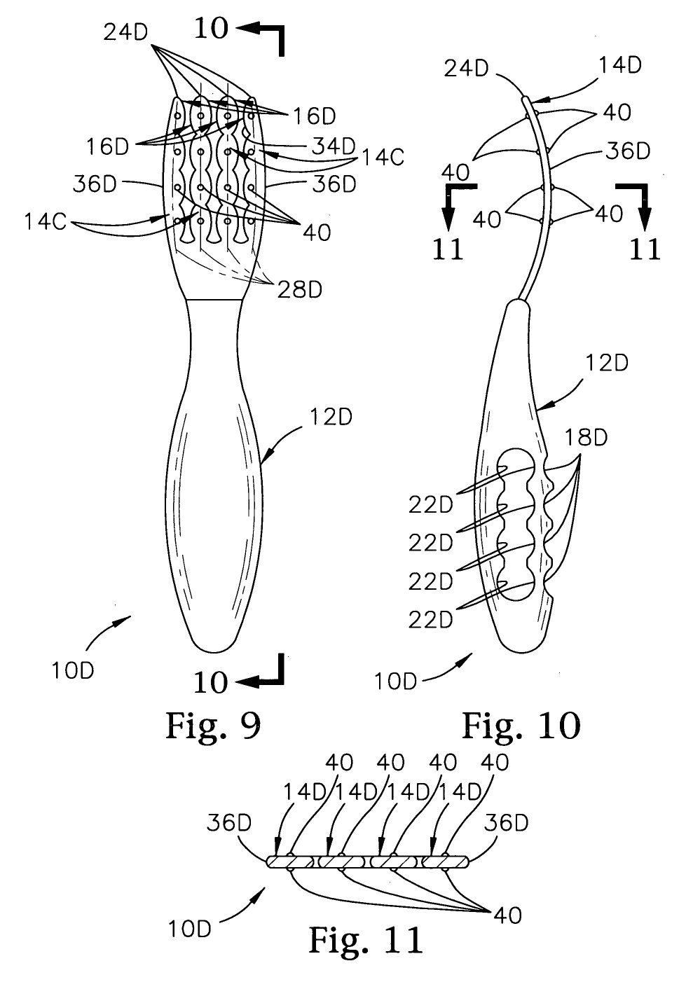

Referring now to FIGS. 9-11, there is shown another embodiment of the food-handling utensil according to the present invention wherein the utensil and similar or like features are identified by the same reference numbers used previously but with the suffix “D” added and significantly different features are identified with new reference numbers. In this embodiment, the food-handling utensil 10D has four tines 14D each with a blunt impaling end 24D and the projections 16D on the tines are aligned and have a semi-elliptical or convex shaped side surface 34D like those in the FIG. 4 embodiment and are provided on only the opposing sides of the tines and not the outermost sides 36D which again may be more suitable for use by those that experience an irritation or uncomfortable sensation from direct contact with an irregular surface.

However and with regard to certain users including children, the elderly and those physically impaired, additional food retention capability may be desirable and for this purpose the tines 14D are provided on their two outwardly and oppositely facing sides with smooth semi-hemispherical shaped projections 40. That are spaced along their centerline 28D and thereby significantly add to the ability of the tines in retaining food but are limited in lateral extent to minimize the degree to which they might result in an irritation or uncomfortable sensation to a sensitive user while on the other hand providing needed additional food retention capability for certain users.

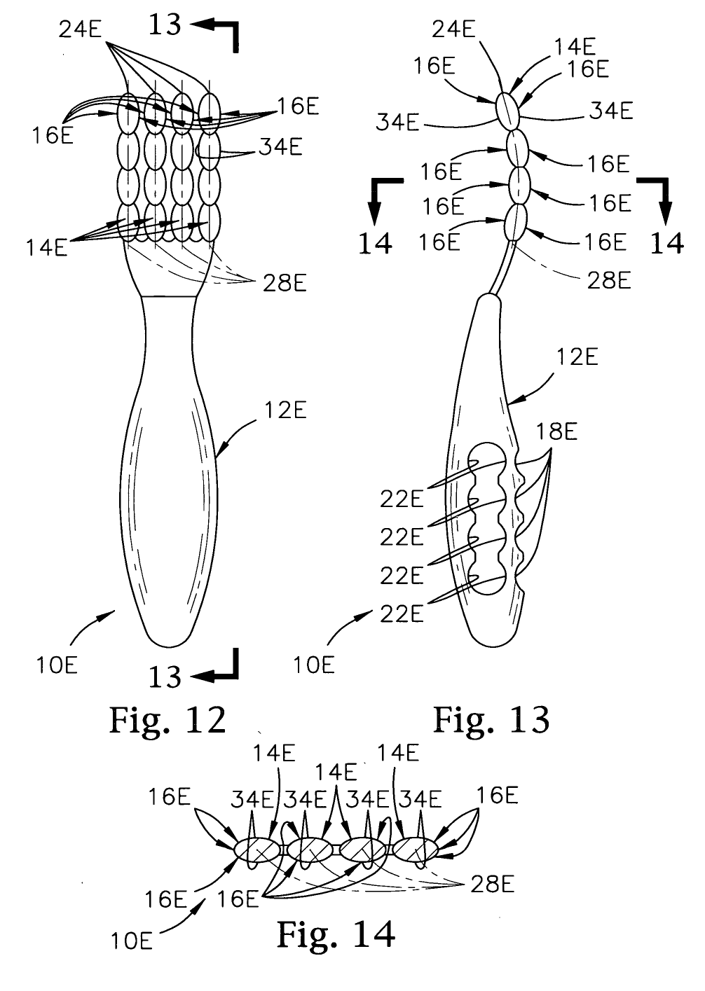

Referring now to FIGS. 12-14, there is shown another embodiment of the food-handling utensil according to the present invention wherein the utensil and similar or like features are identified by the same reference numbers used previously but with the suffix “E” added. In this embodiment, the food-handling utensil 10E has four tines 14E each with a blunt impaling end 24E and the smooth projections 16E on the tines are laterally aligned, have a semi-elliptical or convex shaped side surface 34E like those in the FIG. 4 and FIG. 9-11 embodiments and are now provided on all four sides of the tines. Whereby the projections 16E on all four sides of the tines cooperatively form an elliptical side surface as seen in FIG. 14. Thereby significantly adding to the ability of retaining food while minimizing the degree to which a person may experience an irritation or uncomfortable sensation from direct contact with an irregular or interrupted surface.

It will also be appreciated that having disclosed several exemplary embodiments of the invention, persons skilled in the art may arrive at various versions or modified forms of the invention constituting other embodiments. For example, the impaling distal ends of the tines where the projections have a semi-elliptical shape as in the FIG. 4, FIG. 9-11 and FIG. 12-14 embodiments and in retaining the ability to both impale and retain food can instead be provided with angularly oriented projections like in the FIG. 1-3, FIG. 5, and FIG. 6-8 embodiments. And that the distal ends of the tines in all the embodiments may be provided with an even easier penetrating or pointed end depending on the intended use and users. And therefore it is intended that the invention be to be limited only by the scope of the appended claims.

1. A food-handling utensil comprising at least two tines having opposing sides, said opposing sides having a plurality of laterally extending smooth projections spaced along the length thereof adapted to enter and retain food impaled by the tines and also provide a wedging action on the food to significantly aid food retention but only marginally inhibit release of the food during handling of the food with the utensil.

2. A food-handling utensil as set forth in claim 1 wherein the projections on one tine are aligned with the projections on the other tine.

3. A food-handling utensil as set forth in claim 1 wherein the projections on one tine are staggered with respect to the projections on the other tine.

4. A food-handling utensil as set forth in claim 1 wherein there are at least three tines comprising two outer tines and at least one inner tine located between said outer tines, and said outer tines having an outer side with a plurality of laterally extending smooth projections spaced along the length thereof adapted to engage and retain food impaled by the tines but only marginally inhibit release of the impaled food during handling of the food with the utensil.

5. A food-handling utensil as set forth in claim 1 wherein said tines have at least two sides with a smooth uninterrupted surface along the length thereof.

6. A food-handling utensil as set forth in claim 1 wherein there are at least three tines comprising two outer tines and at least one inner tine located between said outer tines, said inner tine has two sides with a smooth uninterrupted surface extending along the length thereof, and said outer tines have three sides with a smooth uninterrupted surface extending along the length thereof.

7. A food-handling utensil as set forth in claim 1 wherein said projections having a shape defined by a flat leading side surface and a trailing convex side surface, and said flat surface is at an acute angle with respect the centerline of the respective tine and angles in a direction away from the distal end of the respective tine.

8. A food-handling utensil as set forth in claim 1 wherein said projections have a completely convex shape.

9. A food-handling utensil as set forth in claim 1 wherein said projections have a semi-elliptical shape.

10. A food-handling utensil as set forth in claim 1 wherein all the sides of said tines have said projections.

11. A food-handling utensil as set forth in claim 1 wherein all the sides of said tines have said projections, and said projections have a flat and angled leading side surface merging with a trailing convex side surface.

12. A food-handling utensil as set forth in claim 1 wherein all the sides of said tines have said projections, and said projections have an elliptical side surface.

13. A food-handling utensil as set forth in claim 1 wherein all the sides of said tines have said projections, said tines have outwardly facing sides, and the projections on said outwardly facing sides have a semi-hemispherical shape.

14. A food-handling utensil as set forth in claim 1 wherein said handle has an external surface with a plurality of notches adapted to receive the fingers of a person, and said handle has an elongated slot with plurality of oppositely facing pairs of notches adapted to receive the fingers of a person.

15. A food-handling utensil as set forth in claim 1 wherein said tines have a blunt distal end.

16. A food-handling utensil as set forth in claim 1 wherein said tines have an angularly oriented projection at their distal end.

17. A food-handling utensil as set forth in claim 1 further comprising a spoon shaped portion, and said tines being integral with and extending from said spoon shaped portion.
